(19) United States
(12) Patent Application Publication
(10) Pub. No.: US 2026/0318809 A1
(43) Pub. Date: Oct. 15, 2026

(54) BREATHABILITY MEASUREMENT DEVICE

(71) Applicant: EGE ÜNIVERSITESI, Bornova Izmir (TR)

(72) Inventors: Gamze SÜPÜREN MENGÜÇ, Bornova Izmir (TR); Gonca ÖZÇELIK KAYSERI, Bornova Izmir (TR); Ata KIANOOSH, Bornova Izmir (TR); Baris Oguz GÜRSES, Bornova Izmir (TR); Faruk BOZDOGAN, Bornova Izmir (TR)

(73) Assignee: EGE ÜNIVERSITESI, Bornova Izmir (TR)

(21) Appl. No.: 18/871,682

(22) PCT Filed: Dec. 12, 2023
(86) PCT No.: PCT/TR2023/051530

§ 371 Date: Dec. 4, 2024

(51) Int. Cl. G01N 15/08

(52) U.S. Cl. CPC G01N 15/0826; G01N 2015/084

(57) ABSTRACT

The invention relates to a test device for bidirectional breathability measurement of textile samples, in particular masks.

### RELATED FIELD

The invention relates to a test device for bidirectional breathability measurement of textile samples, in particular masks.

### STATE OF THE ART RELATED TO THE INVENTION (PRIOR ART)

According to the state of the art, in the devices developed so far, the permeability of the textile surface to be measured is provided by a vacuum pump operating unidirectionally. All devices designed to measure the air permeability of fabrics and nonwoven surface materials such as masks, have been found to perform the measurement with an air movement based on a unidirectional vacuum system. Such a measurement system does not include a test method suitable for simulating the effect on textile products, such as masks, exposed to bidirectional air movement during breathing.

The fabric breathability measurement system is based on the principle of measuring the pressure difference (delta p) in the closed chamber at the nozzle ends by generating negative pressure with an air suction fan of adjustable volume for the sample placed on the measuring head, and this measurement is made using a well-established differential pressure-flow curve or differential pressure-ventilation scale. Eligibility checks are carried out on the ventilative value of the tested sample. Therefore, the basic component of the device is a differential pressure flow meter. One of the critical parts of a differential pressure flow meter is the pressure level nozzle in the chamber where it is located.

Although parts such as cam, fork, slide block, setting nut are widely used in the fabric air permeability test devices of hydraulic type, sample compression poses a technical challenge. However, these are all manual processes and, in cases such as thickness change, it is inevitable that human error will occur.

Another device in the state of the art is the FX3300 computerized fabric air permeability measuring device developed by the Textest company. This device has a fully automatic test accuracy of ±3%, a pressure range of 98~2500 pa, and can measure air permeability in the range of 2~9000 mm/s. However, the sample is not automatically compressed to the device and it does not have an automatically displaced air flow spray nozzle.

The fabric air permeability test device described in the document no. CN100595557C, which is one of the patent documents in the state of the art, consists of an air flow chamber, one in the lifting pump at the lower end of the air flow chamber and one in the measuring head, in the middle air flow spray nozzle of the air flow chamber. The upper end of the air flow chamber is characterized by a cpu of the control center, a printer being connected to the cpu and the touch input panel. The disclosed air flow spray nozzle is radially distributed at equal distance on the disk, connected by photoelectricity, and the connection switch located at the disk border by cpu consists of a system to change the air flow spray nozzle when the control disk rotates automatically.

The measuring head, which creates the electromagnetic activation, automatically compresses the sample device. The fabric air permeability is measured by connecting to the pressure transducer located at the upper and lower sides of the air flow spray nozzle with the cpu, respectively.

The cpu has two pressure sensors at the upper and lower ends. This enables the measurement of the air permeability of fabrics. It is specified that the pressure difference range of the invention is 50-4000 pa and the current permeability rate is 2-11937 mm/s. The consistency of its repeatability is 99.8% and the test time is specified as 8 s to improve test accuracy and working efficiency.

In document no. EP0327524A3, there is a pressure detecting apparatus designed to detect differential pressures. The apparatus consists of a housing with an internal compartment filled with an incompressible liquid. The first and second diaphragms are kept in this housing to interact with the measured liquids. There is a flexible tube herein and it is connected to one of the diaphragms to detect the differential pressure. One end of the flexible tube is securely mounted to the housing and the other end is connected to the diaphragm. A quartz sensor placed in the core is responsible for detecting the tension applied to the flexible tube by the differential pressure applied to the diaphragm.

The invention according to the document no. EP3791936A1 relates to respiratory analysis used to determine respiratory volume information, such as oxygen uptake value or maximum oxygen uptake value. In particular, it relates to performing respiratory analysis using a filter for supplying filtered air to the person wearing the mask with a flow assisted by a fan. In this system, a pollution mask with a filter and a fan monitors the rotational speed of the fan and the pressure between the mask air chamber and the surrounding environment. The respiratory flow volume information is then obtained from these monitored parameters. This mask functions both as a pollution mask and as an analysis system that provides respiratory flow volume information, for example for personal health and/or fitness monitoring.

It is stated that one or two fans can be included in the mask to increase comfort and effectiveness, and that the fans are switched on during use and can typically be used at a constant voltage. The pressure inside the mask can be measured to adjust the fan speed and it is stated that both pressure and pressure change can be used to control the fan.

The method in the document no. CN109632605b in the state of the art relates to a portable measuring device designed to be used for real-time measurement on a production line. This device is a micro air permeability test device which comprises a box body in which an upper test chamber, a lower test chamber, a fan, a nozzle pressure difference sensor and a sample pressure difference sensor of the measurement system are arranged. The rotating mechanism in the box body is connected with a rotating disk, multiple nozzles are placed evenly in the circumferential direction of the rotating disk, with different ventilation openings. Automated compression of the sample and automatic replacement of nozzles with different measuring ranges can be achieved with automation.

The patent document no. CN110907325A relates to a cantilever type fabric air permeability test device consisting of a cantilever type combined test panel, a test fixture and a test device. The measurement system consists of an air pumping system and a differential pressure gauge connected via pipelines to the lower test chamber, a computer in circuit connection with the air pumping system and differential pressure gauge, and a voltage control device. It is stated that with this method, fabrics of various shapes and sizes can be tested in a non-destructive manner and without cutting a sample piece. It is stated that with the linear module, the height can be adjusted, the test piece can be tightly compressed, gas leakage can be prevented, and the accuracy of the test result can be ensured.

In a common fabric air permeability test device, a sample piece is cut to a specific size according to a standard and the flow passing through the two sides of the sample piece is measured to calculate the air permeability. It is stated that in this method the sample piece is disfigured and that this measurement system is not suitable for multiple sampling and control. It is stated that the developed device enables air permeability tests of porous materials, polyurethane plastic foams, nonwoven surface fabrics and products, and materials used in automotive upholstery to be performed in a non-destructive manner for the sample.

The device described in the patent document no. DE102010019178A1 has a measuring zone particularly suitable for testing a flat textile sample and an air blowing system used to generate negative pressure. The fan is connected to the measuring zone in such a way that air passes through the measuring body as it flows through the textile sample. The system comprises a device (first device) for recording the pressure difference between the two sides of the textile sample. It also comprises a second device and an evaluation unit used to determine the air flow rate within the measuring zone to calculate the air flow through the textile sample, taking into account the input values of the first and second devices. The evaluation means according to the invention are in particular connected to a device which compensates for the environmental conditions of the location of the device. In particular, it can be advantageously ensured that the balancing device has at least one device for detecting the absolute pressure of the ambient air. The said device benefits from the fact that in the calculation of the air permeability it is necessary not only to take into account or adjust the pressure difference between the ambient air and the pressure in the measuring zone, but also to include this in the density calculation of the air and therefore in the calculation of the air permeability of the textile sample, thus taking into account the absolute value.

The air permeability test device described in the patent document no. KR102174605B1 enables fast and accurate measurement of the air permeability of many fabrics and filters, including fabrics, nonwoven surfaces, woven surfaces, etc., at the same pressure automatically by means of nozzles of different sizes. Various test standards can be tested by improving errors that may occur during nozzle replacement and by means of a sample compression jaw, which is used for fixing samples of various sizes. In general, air permeability refers to what occurs due to the pressure difference or concentration difference between both sides of the membrane as air passes through the porous membrane, and therefore, the air permeability of a textile product refers to the degree of air penetration.

The air permeability test of the fabric is a method of measuring the amount of penetrating air or air flow rate in a certain area in a certain time by allowing air to pass vertically under a certain area and pressure of the fabric. In addition, recently, air permeability of masks and filters is measured and classified according to numerical values.

The air permeability test device is a specialized equipment capable of accurately testing the resistance of air flow passing through a filter surface in the form of a fiber-containing product and a mask under a certain area and pressure of the filter in the form of this product and mask. The conventional air permeability test device has a sample compression jaw that fixes the fabric, nonwoven surface, wovens, etc. so that the fabric does not move, and a supply tube that allows air to flow in a straight line under the jaw. The supply tube consists of a nozzle for spraying air from the air blowing unit and a brush for air delivery, and the air permeability is measured under the same pressure.

The air permeability test device is installed by replacing nozzles of different sizes in the nozzle area so that the air pressure can be measured differently. To change the level, the operator manually separates and joins the nozzle part from the supply tube. If the nozzle is not positioned correctly in the center of the supply tube, there can be many errors in the measurement, which can also create a problem of not being able to perform the replacement quickly due to the laborious nature of this process. Instead of manually replacing the nozzles during air permeability measurement, the said invention enables automatic replacement of nozzles of different sizes, thus avoiding errors caused by manual operation. In this air permeability test device, a part of the nozzle rotation table is located between the upper and lower nozzle tubes as a nozzle insertion hole, and the nozzles of different sizes are arranged in a circular row on the upper surface of the nozzle rotation table and the nozzle rotates. The nozzle motor is located in the lower part of the table, connected by the nozzle shaft, and then the nozzle selected by rotation of the nozzle rotation table by the driving of the nozzle motor is located between the upper and lower nozzle tubes, and the air flow supplied from the ring blower passes.

By rotating the nozzle rotation table, the upper and lower nozzle tubes are inserted into the nozzle insertion hole and the nozzle is rotated by changing its position.

As described above, the said device measures many textile products and filters, including fabrics, nonwoven surfaces, wovens, etc., under the same pressure and also with nozzles of different sizes, measuring the breathability of the surfaces as in the prior art. Furthermore, instead of measuring the air permeability by separating the air permeability from the upper and lower nozzle tubes, nozzles of different sizes are arranged in a circular shape on the nozzle rotation table and the nozzle is moved between the upper and lower tubes by rotating the nozzle motor. With the rotation of the nozzle motor, the air permeability is measured by positioning the rotation table with the nozzle insertion hole, the errors that may occur due to manual nozzle replacement work are improved, and the nozzle replacement work is automatically performed quickly and accurately.

Another device in the state of the art relates to an air permeability measuring apparatus comprising a test head with an opening, a vacuum pump, a compression arm and a disk rotatable about its center. The orifice plate (disk) is placed between the tubes and the vacuum pump and has a plurality of holes thereon. This disk also comprises at least one slit and/or an air jet nozzle targeting forward movement from the disk. The slit on the disc extends from the periphery of the orifice disc to a central opening of the disc, and when the slit is in the cleaning position, the length of the slit overlaps a contact area between the first end of one of the tubes and the surface of the orifice.

It is stated that the orifice disk is made of a material such as metal, ceramic, resin, plastic, where the material can be used as coated or uncoated.

For the measurement in the patent no. Wo2013007282, the test head consists of an upper part and a lower part that can be connected to each other when pressed. There is provided an analysis unit designed for the recording and storage of data arrays using software integrated into the compression arm used for this purpose.

It is stated that the device can be used to determine the air permeability of all types of flat materials, foam blocks and the measurement range covers high-density papers and air cushion fabrics as well as nonwoven surface fabrics.

In this apparatus developed to test the permeability of porous mesh structures, the porous mesh structures to be tested are placed on the test head of the apparatus. The test head comprises at least one opening and a vacuum pump connected to the test head. Air is drawn through the mesh structure and then through the opening. The test head also comprises at least one static connection point with the opening. The static connection point is positioned very close to the mesh and the static pressure inside the opening is measured before leaving the opening.

A pressure transducer is connected to the static connection point and this transducer allows the measurement of the pressure reduction across the mesh structure. If the volumetric flow rate of air across the mesh structure is kept constant, the pressure transducer output represents the permeability of the mesh. If the pressure difference across the mesh structure is kept constant, the measurement of the volumetric flow rate of air across the mesh represents the permeability of the mesh.

This invention provides for the measurement of the permeability of porous sheet materials and is of a structure that allows continuous measurement of the permeability of mesh structures produced by a papermaking machine and flowing during production. An apparatus for measuring the permeability of a porous sheet material is described in the document no. U.S. Pat. No. 2,861,451. In this patent document, the surface of the material is supported on a perforated planar surface, allowing the air underneath to flow through the porous material and then through the perforated planar surface. It is then discharged into the atmosphere after flowing through a conical, transparent float tube comprising an indicator. The float, which positions itself along the tube according to the speed of the air flowing through the tube, is an indicator of the permeability of the porous material. This apparatus described in the Emmons patent is stated to be unsuitable for continuously measuring the permeability of a moving mesh.

In a preferred embodiment of the apparatus, the test head comprises a static ring that communicates with the opening and with the pressure chamber around the entire circumference of the plenum and the opening. The pressure transducer is connected to the plenum, thus allowing a measurement of the average pressure reduction across the mesh, as measured around the entire circumference of the opening.

In a preferred embodiment of the apparatus (U.S. Pat. No. 4,311,037), the air flow through the test head is kept constant and the pressure reduction across the mesh is measured as an indicator of the permeability of the mesh-structure. In an alternative embodiment of the apparatus, the pressure reduction across the mesh is kept constant and the flow rate of air across the detection head is measured to determine the permeability of the mesh.

The measuring device developed with the invention in the patent document with application no. IN/PCT/2002/01277/DEL and designed to measure the permeability of materials comprises a stationary vacuum source connected to a liquid capacitance container via a channel; a pressure transducer connected to an amplifier by conductors; and an indicator for monitoring the source. A fluid-tight disk is placed on the surface of the material to create a fluid flow gap between the disk and the surface. The disk is connected by a channel to a tube (flow blocker tube) that provides a high impedance to the liquid flow. The other end of the tube is in contact with the container and the liquid. A transducer is connected to the system along the tube so that the fluid flow can be monitored.

The liquid-tight seal is located around the circumference of the disk and extends radially outwards on the surface. Assuming that the material has some degree of permeability, air can penetrate through the material beyond the circumference of the seal and into the gap. This flow creates a constant pressure differential across the tube. This pressure difference is also detected by the transducer and displayed on the display. In this way, permeability can be determined.

As a result, in all these measurement systems, efforts to apply unidirectional air flow in the determination of air permeability were preferred.

### SUMMARY AND OBJECTS OF THE INVENTION

The invention relates to a test device for bidirectional breathability measurement of textile samples, in particular masks.

The developed device has unique features in terms of technical drawing and ergonomics, considering the design features of the existing devices identified in the literature research, and is a device that eliminates the disadvantages of the state of the art and offers new technical advantages to the related field.

In the device developed with this invention, it is ensured that this test can be performed with a device that can perform measurements at the same time while working in both suction and force directions by utilizing a bidirectional piston pair in a closed circuit with a very fast and simple system, thus enabling the permeability test to be performed on textile samples in the inhalation and exhalation directions.

The developed system utilizes a bidirectional vacuum unit. By means of this unit, it is possible to ensure air movement in both inhalation and exhalation directions and the measurement can more accurately simulate the real situation.

The device developed with this invention is intended to
Ensure the breathability of the masks with air movement in 2 different directions, i.e. the inhalation and exhalation directions,
Utilize a piston pair operating in a closed circuit,
Eliminate the need for manual pressing and compressing forces to compress the sample during measurement,
Utilize a pneumatic system to compress the sample during measurement.

Some features of the measuring device developed with this invention are as follows:
With the linear movement motor, the air flow of the constant air compression unit can be realized at the desired constant speeds.
By changing the settings on the linear movement motor, the air flow can also be realized at different preferred rates.
With this mechanism, the test can be performed bidirectionally as in the inhalation and exhalation movement.
With a unit capable of compression and force movement in a constant volume, it is very easy to provide air movement at a constant and adjustable speed and it offers the possibility of precise measurement.

### DESCRIPTIONS OF THE FIGURES DISCLOSING THE INVENTION

The figures and related descriptions necessary for a better understanding of the subject of the invention are as follows.

FIG. 1: test equipment for measuring the pressure difference (EN 14683)

FIG. 2: a schematic view of the measurement mechanism of the developed device

FIG. 3: a front perspective view of the developed device

FIG. 4: a rear perspective view of the developed device

FIG. 5: a perspective view of the measuring head

FIG. 6: a perspective view of the measuring head drive unit

FIG. 7: a perspective view of the lower measuring head

FIG. 8: a perspective view of the air compression-suction unit

### DEFINITIONS OF THE ELEMENTS AND PARTS CONSTITUTING THE INVENTION

The parts and elements included in the mask breathability measurement device developed with this invention are separately numbered and are given below.
1. Linear movement motor
2. Constant air compression unit
3. Sealed compression plate
4. Textile sample
5. Sample table
6. Pressure sensor connection-1
7. Pressure sensor connection-2
8. Particle measurement sensor-1
9. Particle measurement sensor-2
10. Protection housing
11. Pneumatic movement piston
12. Main passage
13. Lower measuring head
14. USB port
15. Display
16. Printer
17. Operating buttons
18. Switch
19. Electrical panel
20. Panel transition connection
21. Upper measuring head
22. Hose connection apparatus
23. Lower head pressure sensor connection
24. Air flow sensor
25. Pneumatic cylinders
26. Electric linear actuator motor
27. Pressure sensor
28. Speed control card

### DETAILED DESCRIPTION OF THE INVENTION

The invention relates to a test device for bidirectional breathability measurement of textile samples, in particular masks.

The developed device is realized using a suction force system which enables breathability testing for textile products, for example masks, and which can perform measurements while operating both in the suction and force directions utilizing a piston pair that operates bidirectionally, similar to the air movement in respiration, thus allowing permeability testing in the inhalation and exhalation directions.

The said invention is a test device that enables the bidirectional permeability testing of the breathability of textile samples (masks, etc.) in both inhalation and exhalation directions and operates in a closed circuit and it has the following elements. These elements are as follows:
Textile sample (4) tested for permeability in both inhalation and exhalation directions,
Sample table (5) on which the textile sample (4) is placed,
At least one main passage (12), which ensures that the textile sample (4) to be tested is fixed before starting the test,
Sealed compression plate (3) used for compression fixing of the textile sample (4)
Since air leakage may occur in case of any machine malfunction that may occur in the measuring zone, a measurement housing (10) that prevents this from harming the person using the machine and protects the hand from the risk of getting stuck,
Safety double operating buttons (17) to activate the device, which operate when two buttons are triggered together,
Movable measuring head used for measurement, consisting of two elements, the upper measuring head (21) and the lower measuring head (13),
Bidirectional pneumatic movement piston (11) for measurement, which allows the measuring head to move in the vertical direction and, when activated, allows the upper measuring head (21) to move in the downward direction,
Upper measuring head (21) connected to the movement piston (11), located in the upper part of the device, used as a measuring apparatus, and connected to the main passage (12) element,
At least one panel transition connection (20) used as a joining apparatus to which the air supply tubes are attached,
At least one constant air compression unit (2), which enables measurements at air flow rates of 8 l/min and lower, which can perform compression and force movements in a constant volume, which is used to realize the air flow at the desired constant rate, consisting of units operating in the suction and force direction,
Electric linear actuator motor (26) which enables the constant air compression unit (2) to move at required different rates,
Speed control card (28), which allows movement at different speeds while performing the movement process,
Linear movement motor (1), which enables the air flow to be realized at the desired constant speed with the constant air compression unit (2) and the test to be performed bidirectionally,
Lower measuring head (13) connected to the pneumatic movement piston (11), located at the upper part of the machine, and used as a measuring apparatus,
Hose connection apparatus (22) which is the connecting piece used for connecting the upper measuring head (21) to the flow sensor (24),
Pressure sensor connection including the pressure sensor connection-1 (6) and the pressure sensor connection-2 (7), used to calculate the pressure difference,
Lower head pressure sensor connection (23), which is the apparatus that connects the sensor to the measurement point, located at the lower part of the area where the sample is placed,
At least one flow sensor (24) for measuring the air flow rate at the lower part of the lower head pressure sensor connection (23), which is used to detect a possible hose connection problem or leakage,
Particle measurement sensor including the particle measurement sensor-1 (8) and particle measurement sensor-2 (9) elements to detect microparticles leaking into the measuring zone.

The said textile sample (4) is a mask.

The said textile sample (4) to be measured is a mask fabric, filter fabrics, membrane material or other nonwoven surfaces.

The said textile sample (4) is positioned at the upper part of the lower measuring head (13).

The said measurement housing (10) is made of plexiglass material.

The device comprises at least one usb port (14) that enables connection with electronic devices (e.g. computer, etc.).

The said hose connection apparatus (22) is preferably brass or stainless, non-corrosive alloy or metal.

Panel transition connections (20) are panel transition apparatus connections for electric and air inlet and panel transition apparatus connections for upper pressure sensor air connection.

The constant air compression unit (2) is a pneumatic cylinder (25).

It has a display (15) where the test result is shown after the pressure sensor-1 (6) and pressure sensor-2 (7) perform measurements and make the necessary calculations.

It has an electrical panel (19) located at the lower part of the device, which ensures the transmission and distribution of the electricity supplied to the device.

The said flow sensor (24) is a flow meter.

In the device, the linear movement motor (1) and the constant air compression unit (2) ((units working in the suction and force direction)) ensure that the air flow is realized at the desired constant speed. With this mechanism, the air movement and therefore the test can be performed bidirectionally, as in the inhalation and exhalation movement.

The measurement system described in the breathability test specified in the standard (EN 14683:2019+AC) requires measurement at a very low air speed. With the defined components of the said device, this measurement is difficult to perform precisely and this is the most important point of the measurement. In the measurement system designed with the invention, this disadvantage is eliminated and it is very easy to provide air movement at constant speed with a unit (pump) that can make compression and force movements in a constant volume and a precise measurement opportunity is created.

Another unique technical feature of the device is that this movement allows determination of the result by measuring the placed mask material in both directions, i.e. inhalation and exhalation, on the sample (4) to be measured.

The main features of the developed breathability measuring device are summarized in the EN 14683:2019+AC standard, and the appearance of the experimental setup for this device is given in FIG. 1. In the experimental setup described in the standard, in order to make this measurement, the pressure difference required to draw air through a measured surface area at a constant air flow rate is measured. A water-filled (or digital) differential manometer is used to measure the pressure difference and a mass flow meter is used to measure the air flow. An electric vacuum pump drives air through the test equipment and a needle valve is used to adjust the air flow rate. The mass flow meter(s) to be used in this system are capable of measuring 8 l/min air flow. The sample holder consists of the alignment of the upper and lower holder with a mechanical compression mechanism. It is required to consist of a mechanism for adjusting the compression pressure, and in the lower or upper part, a threaded system can be used. The inner diameter of the upper holder and the lower holder in the contact area with the filter material must be (25±1) mm. The sealing between the upper and lower holders and the filter material should consist of metal-to-metal contact.

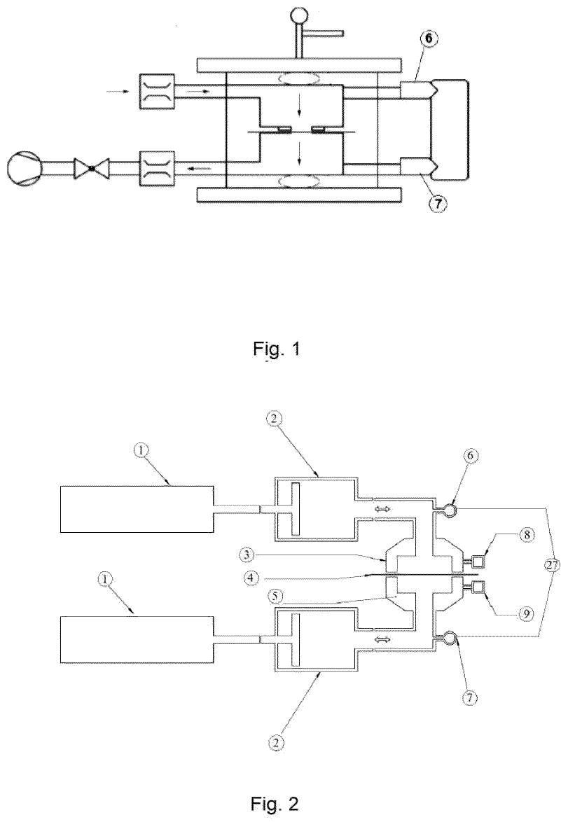

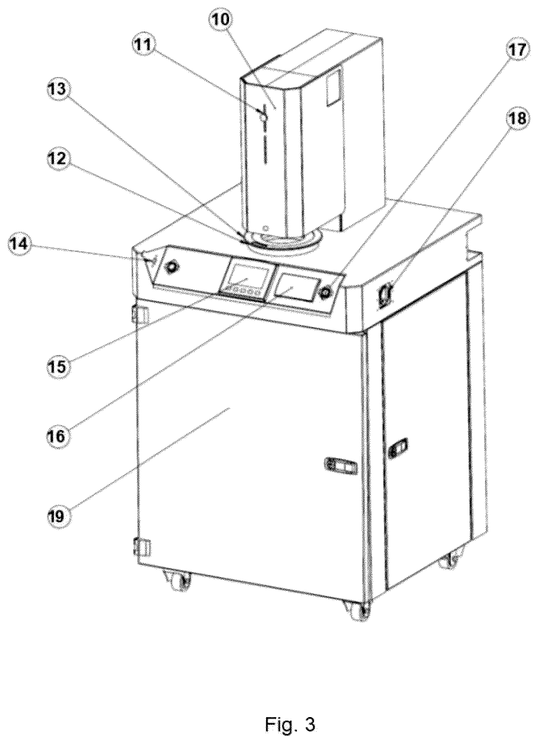

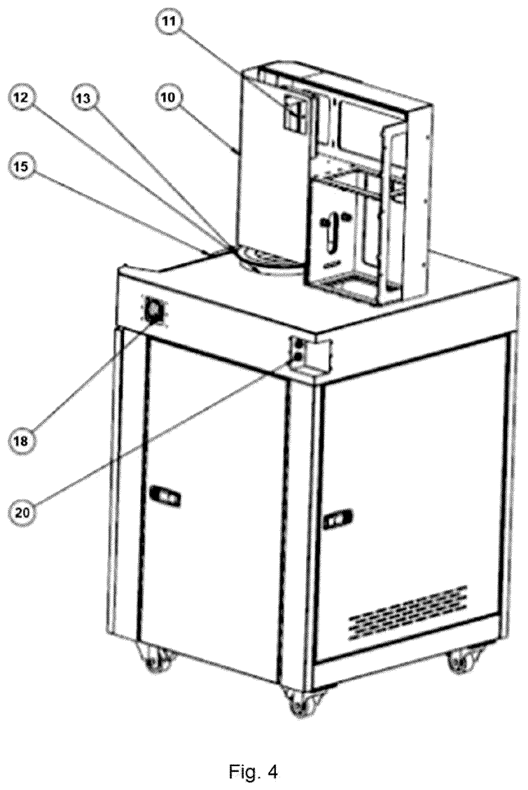

The device is designed to provide the features described above and its technical drawing is shown in FIG. 2.

In this designed device, the air flow of the constant air compression unit (2) is created at the desired constant speed with the linear movement motor (1). With this mechanism, it is possible to perform the test bidirectionally as in the inhalation and exhalation movement.

In the developed device, it is easier to provide air movement at constant speed by using the constant air compression unit (2) (pump) with a unit capable of performing compression and force movements in a constant volume, and a precise measurement is achieved.

The textile sample (4) to be measured can be various materials such as mask fabric, filter fabrics, membrane materials or other nonwoven surfaces. The measurement sample (the material to be measured (textile material (4)) placed on the sample table (5) is compressed with the sealed compression plate (3) during the measurement. The device has pressure sensor connections. These connections are the pressure sensor connection-1 (6) and pressure sensor connection-2 (7), which are used to detect the pressure difference between the two sides of the placed sample. The particle measurement sensor 1 (8) and the particle measurement sensor 2 (9) detect microparticles leaking into the measuring zone.

The measurement housing (10) is a plexiglass housing which ensures that the measuring zone operates in accordance with occupational safety. For the measurement, the movement of the measuring head in the vertical direction is provided by the pneumatic movement piston (11). The measurement sample can be fixed before starting the test by means of the part called the main passage (ring) (12). This part connects the area located in the lower part and identified as the lower measuring head (13) to the measuring apparatus. The connection of the device with the computer can be realized via the usb port (14). The test result can be seen on the display (15) and can also be printed out by means of a printer if desired.

When the test is to be performed, the switch (18) is first turned on by checking that there is an air connection. The textile sample (4) is placed on the upper part of the lower measuring head (13). The device is operated by means of the operating buttons (17).

For occupational safety, the device operates by pressing two buttons at the same time. When the button is pressed, the pneumatic movement piston (11) is activated to move the upper measuring head (21) in the downward direction. The upper measuring head (21) is an area-specific measuring apparatus connected to the piston and located at the upper part of the machine. The hose connection apparatus (22), which is the connecting piece used for connecting the upper measuring head (21) to the flow sensor (24), can preferably be made of brass or other stainless, non-corrosive alloys or metals.

The lower head pressure sensor connection (23), located at the lower part of the area where the sample is placed, is the apparatus for connecting the sensor to the measurement point. At the bottom of this part is the flow sensor (24), which is a flow meter that measures the air flow rate. The constant air compression unit (the units operating in the suction and force direction) (2) is shown as pneumatic cylinders (25) on the machine. This system gets its movement from the electric linear actuator motor (26).

A “speed control card” (28) was included in the system. Adjustment for speed change can be made on the display (15). When a speed change is desired, this data transmitted from the speed control card in the form of an analog or digital signal is received by the PLC or microcontroller or microcomputer and transferred to the speed circuit as a speed instruction. The speed circuit then allows the piston (25) speed to be changed by increasing or decreasing the speed of the motor to reach the instructed position, allowing the test speed to be changed as desired.

The pressure sensor-1 (6) and pressure sensor-2 (7) perform measurements and make the necessary calculations and the measurement result is displayed on the display (15). The electrical panel (19) is located at the lower part of the machine.

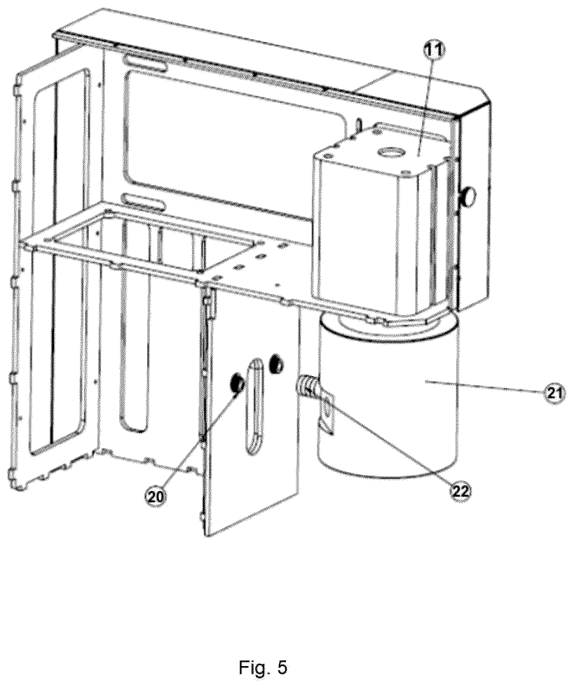

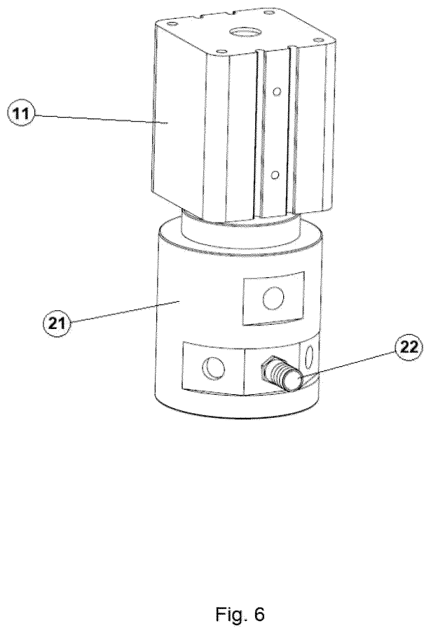

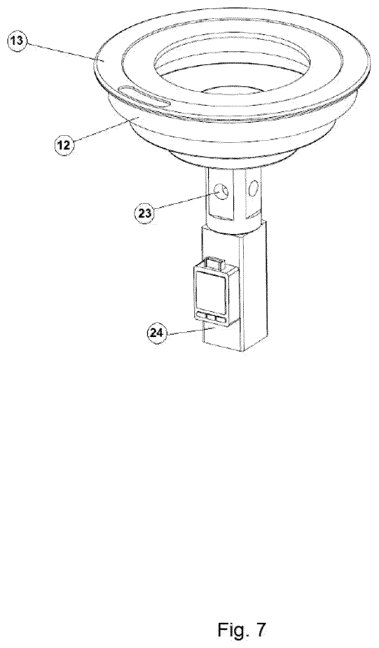

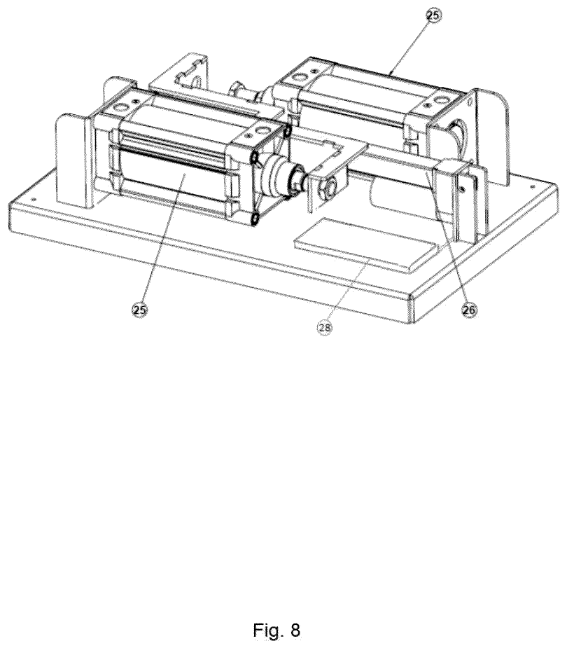

Panel transition connections (20) are the joining apparatus to which the air supply tubes are attached. This apparatus is in the form of panel transition apparatus connections for electric and air inlet (FIG. 4) and panel transition apparatus connections for upper pressure sensor air connection (FIG. 5).

The pneumatic cylinders (25) have constant volume and constant speed and are sufficient to determine the usual flow. However, an air flow sensor (24) is also installed in the system to detect a possible hose connection problem or leakage.

1. A test device, enabling the bidirectional permeability testing of the breathability of textile samples in both inhalation and exhalation directions, and operating in a closed circuit, comprising:
textile sample tested for permeability in both inhalation and exhalation directions,
sample table on which the textile sample is placed,
at least one main passage which ensures that the textile sample to be tested is fixed before starting the test,
sealed compression plate used for compression fixing of the textile sample,
measurement housing, which prevents air leakage that may occur in case of any machine malfunction in the measuring zone from harming the person using the machine,
safety double operating buttons to activate the device, which operate when two buttons are triggered together,
movable measuring head used for measurement, consisting of two elements, the upper measuring head and the lower measuring head,
bidrectional pneumatic movement piston for measurement, which allows the measuring head to move in the vertical direction and, when activated, allows the upper measuring head to move in the downward direction,
upper measuring head connected to the movement piston, located in the upper part of the device, used as a measuring apparatus, and connected to the main passage element,
at least one panel transition connection used as a joining apparatus to which the air supply tubes are attached,
at least one constant air compression unit, which enables measurements at air flow rates of 8 l/min and lower, which can perform compression and force movements in a constant volume, which is used to realize the air flow at the desired constant rate, consisting of units operating in the suction and force direction,
electric linear actuator motor-which enables the constant air compression unit to move at required different rates,
speed control card, which allows movement at different speeds while performing the movement process,
linear movement motor, which enables the air flow to be realized at the desired constant speed with the constant air compression unit and the test to be performed bidirectionally,
lower measuring head connected to the pneumatic movement piston, located at the upper part of the machine, and used as a measuring apparatus,
hose connection apparatus which is the connecting piece used for connecting the upper measuring head to the flow sensor,
pressure sensor connection including the pressure sensor connection-1 and the pressure sensor connection-2, used to calculate the pressure difference,
lower head pressure sensor connection, which is the apparatus that connects the sensor to the measurement point, located at the lower part of the area where the sample is placed,
at least one flow sensor for measuring the air flow rate at the lower part of the lower head pressure sensor connection, which is used to detect a possible hose connection problem or leakage,
particle measurement sensor including the particle measurement sensor-1 and particle measurement sensor-2 elements to detect microparticles leaking into the measuring zone.

2. The device according to claim 1, comprising where the said textile sample is a mask.

3. The device according to claim 1, comprising where the said textile sample to be measured is mask fabric, filter fabrics, membrane materials or nonwoven surfaces.

4. The device according to claim 1, comprising where the said textile sample is positioned at the upper part of the lower measuring head.

5. The device according to claim 1, comprising where the said measurement housing is made of plexiglass material.

6. The device according to a claim 1, comprising where the device comprises at least one Usb port that enables connection with electronic devices.

7. The device according to claim 1, comprising where the said hose connection apparatus is brass or stainless, non-corrosive alloy or metal.

8. The device according to claim 1, comprising where the said panel transition connections are panel transition apparatus connections for electric and air inlet and panel transition apparatus connections for upper pressure sensor air connection.

9. The device according to claim 1, comprising where the said constant air compression unit is a pneumatic cylinder.

10. The device according to claim 1, comprising where it has a display where the test result is shown after the said pressure sensor-1 and pressure sensor-2 perform measurements and make the necessary calculations.

11. The device according to claim 1, comprising where it has an electrical panel located at the lower part of the said device, which ensures the transmission and distribution of the electricity supplied to the device.

12. The device according to claim 1, comprising where the said flow sensor is a flow meter.
